(19) United States
(12) Patent Application Publication
(10) Pub. No.: US 2018/0055732 A1
(43) Pub. Date: Mar. 1, 2018

(54) Pill-Safe

(71) Applicant: Sameer Soliman, San Antonio, TX (US)

(72) Inventor: Sameer Soliman, San Antonio, TX (US)

(21) Appl. No.: 15/243,965

(22) Filed: Aug. 23, 2016

(51) Int. Cl. A61J 1/03; A61J 7/04

(52) U.S. Cl. CPC A61J 1/03; A61J 7/0472; A61J 7/0418

(57) ABSTRACT

A substance-dispensing device that is programmed by a healthcare provider and whose bulk medication supply is inaccessible to a patient or user at one time. The user will only have access to the dose programmed by the healthcare provider at a specified time and not have access to the internal supply of the medication. The dispensing device denies medication requests to anyone except those authorized by the healthcare provider. The dispensing device keeps a record of the device access and functions performed in the database of the device. The dispensing device will only dispense medication when medication is requested and only if the medication is due. The dispensing device is re-usable and may only be setup by the prescribing authority and filled by the healthcare provider or pharmacist who is assigned to the device.

### BACKGROUND OF THE INVENTION

### Field of the Invention

This invention relates to the control and administration of items, especially medication, and particularly schedule II drugs such as narcotics, which are commonly prescribed by physicians and often end up abused either by patients or by others with access to the medications. Specifically, this device changes the way drugs, particularly those with the potential for abuse, are administered to patients. There is a strong need to control who has access to these drugs and when the access is granted.

Currently, when a physician writes a prescription for a drug, the patient receives a month's supply of the drug, making supervision of who receives the drug and how often it is administered difficult. Furthermore, once a patient picks up medication from a pharmacy, the prescribing physician lacks any control of the medication. Additionally, in the unfortunate event that the patient or an individual with unauthorized access to a patient's medication sustains injury or death due to the medication, blame is often placed on the physician for lack of oversight of the prescribed medication.

Presently, the only ways for physicians to monitor narcotics and other Schedule II medications include conducting random urine drug screens as well as checking a state's prescription monitoring program to determine how often a patient is filling his/her medication. Neither method indicates whether a patient is using medication with more frequency than prescribed or if other individuals have unauthorized access to the medications.

### Description of the Related Art

The prior art includes many different types of pill dispensers. These dispensers are convenient in that they allow the patient needing the pills to receive the appropriate medication at the appropriate time. The dispensers seek to eliminate human error in both the type of pill dispensed and the time in which it is dispensed. They may also have an alarm to remind a patient when a pill is needed.

Additionally, prior art includes a pill box cap that does not unlock except with one's fingerprint, thus controlling who may open that specific prescription bottle. The prior art specifies that if tampering is noticed, a chemical may be sprayed on the medication to render it inactive.

These aforementioned ideas seek to make dispensing of medication convenient for a user and allow the user to control who receives the medication.

The device of the present invention is different from the prior art in that, for certain medications, the present invention gives the provider, most often being the pharmacist or prescribing physician, complete control as to how much, how often, and to whom the medication is delivered. Only the specific patient or user has the ability to request the medication, and the device's computer determines when dispensing is appropriate. In addition, the locking mechanism allows only the appropriate personnel to refill and adjust the dosing frequency.

### BRIEF SUMMARY OF THE VARIOUS EMBODIMENTS OF THE PRESENT INVENTION

The dispensing device in the present invention comprises of a substance dispenser as well as a user interface for the appropriate personnel to control dispensing of medication.

Unlike current pill dispensers on the market that are geared towards ease of use for the patient and reminding him/her to take the medication, the device of the present invention is geared towards allowing the physician to have absolute control of the prescription. This control prevents abuse of the medication and prevents the medication from being distributed and sold on the black market. Additionally, only an authorized provider (often physician or pharmacist) will have access to the medication stored inside the device (i.e. the medication that has not yet been dispensed).

The dispensing device encompasses a container holding the prescribed medication. The container is fool proof, tamper resistant and has a unique identifier to a specific patient, hereby known as the “user”. The assignment of a device to a user and the device's unique identifier can be uploaded into a state's prescription monitoring program to allow further regulation of the medication use.

The dispensing device additionally has means to identify the person that is requesting the medication. The dispensing device is programmable by the provider to only allow the medication to be dispensed to the appropriate person or persons with authorized access. There are multiple ways to restrict access, including one or more of the following: passcodes, voice recognition, fingerprint recognition, and retinal scans. If an unauthorized person is requesting access to the medication, the device will not dispense the medication. Additionally, if an authorized user is requesting access to the medication but the user is not due for the medication, the device will not dispense the medication and will alert the user.

Furthermore, the device contains a computer unit that may perform any of the following operations:

1) determining by clock or timer if a dose may be given when the user requests it (i.e. if the request is within the allotted time designated by prescribing physician)

2) determining if the recognition input given is specific to the user who is allowed access (including combination code and fingerprint recognition)

3) maintaining a log of every time the user requests medication (and whether or not the medication was given)

4) maintaining a log of the last time the device was accessed and by whom

5) monitoring amount of medication the dispensing device currently has available

6) monitoring level of battery power available to the device.

The dispensing device of the present invention should be re-usable so that the user must bring the device back to the authorized provider in order to have the medication refilled. The data stored on the device can be uploaded into a state's prescription monitoring program. From the log of the device, a designated healthcare provider will notice if the device has been tampered with, if the user is requesting medication too often (which may alert the practitioner that the user needs an increased dose or other prescription modification), or if the user has unused medication which may be discarded or re-supplied for the following month.

The dispensing device also has the ability to interact with the authorized healthcare provider. This interaction may be accomplished using an application with a computer interface or personal tablet interface. The dispensing device may communicate with the data log of the device information via wired or wireless connection. This designated prescriber is able to monitor the device to determine such information as:

1) the number of pills remaining to be dispensed

2) the number of requests the user made for medication, including how many were given and how many requests were denied

3) the time of day the user typically makes the most requests for medication

4) the last time the dispensing device was opened

5) the battery life of the dispensing device, and

6) the individuals authorized to access the dispensing device and the means of authorization.

Additionally, the authorized healthcare providers may open the dispensing device to manually check the contents of the device, as well as remove or add the appropriate medication. The authorized healthcare provider also has the ability to modify and reprogram any aspects of the dispensing schedule.

### BRIEF DESCRIPTION OF THE DRAWINGS

FIG. 1 is a likely isometric view of the exterior of the dispensing device

FIG. 2 is a likely isometric view of the exterior of the dispensing device, illustrating a communication port

FIG. 3 is a likely view of the exterior of the dispensing device

FIG. 4 is a likely view of the interior of the dispensing device

FIG. 5 is a flowchart depicting a likely process for user access

FIG. 6 is a flowchart depicting a likely process for healthcare provider access

FIG. 7 is a context diagram depicting a likely process model for the dispensing device

### DETAILED DESCRIPTION OF THE INVENTION

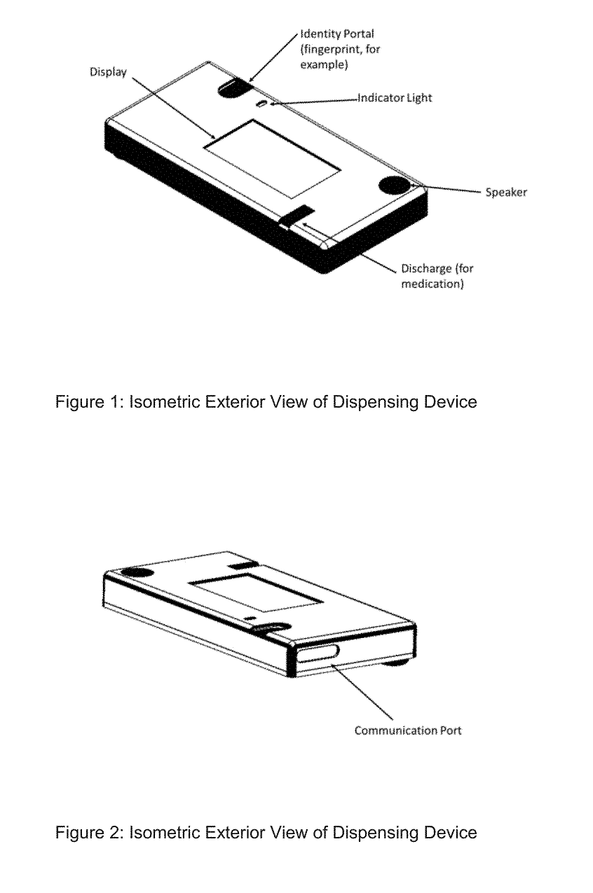

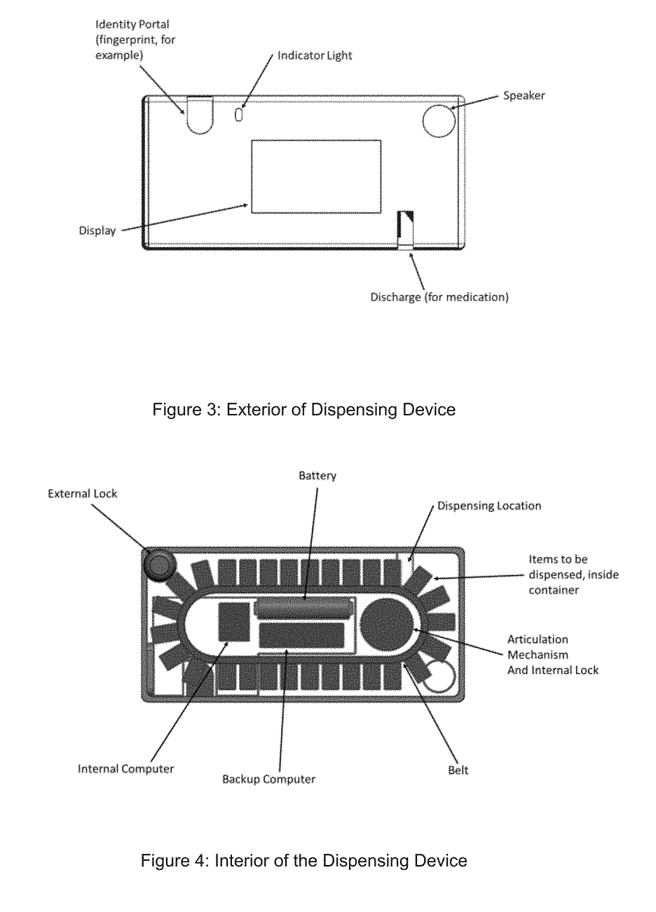

FIGS. 1, 2, and 3 illustrate a possible external view of the dispensing device. The outer shell of the dispenser should be made of a hard substance, preferably a light metal or a hard plastic. The exterior should be waterproof and able to handle the day-to-day activity of being transported in a purse or pocket. Additionally, the material should be able to show evidence of tampering.

A section of the outer case will be reserved for user access point in order to determine if the person or persons requesting the medication is authorized to make the request. The mode for confirming identity may be either of the following including a combination of the following: fingerprint recognition, microphone for voice recognition, or a combination code. Although the input required for identity confirmation is programmed according to preferences of an authorized provider or user, if a combination code is utilized, then a voice activation requirement should be added for confirmation.

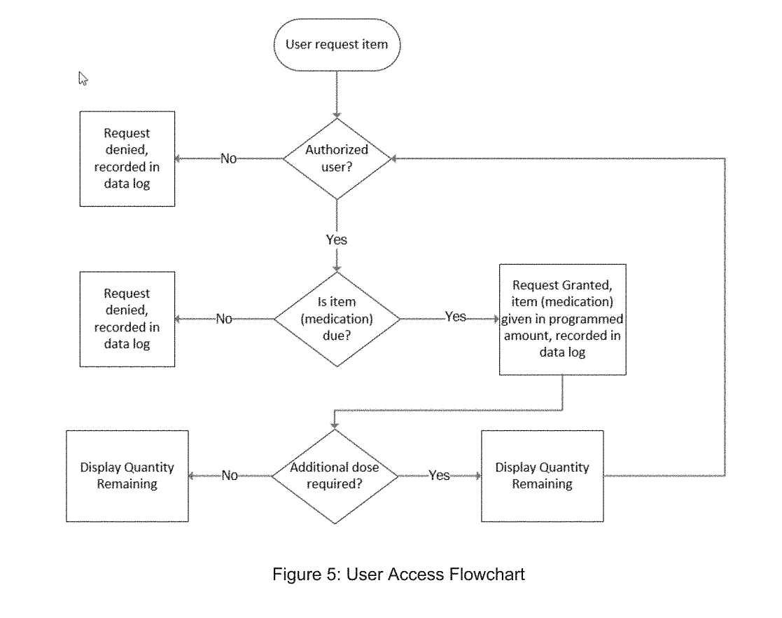

This input is relayed to the internal computer for processing. If the person requesting medication is deemed not to have access by the internal computer, medication will not be dispensed and an appropriate alert will be given (see FIG. 5). This alert may include the display of a red light or an audible response indicating that an unknown person has requested medication. Additionally, if the computer determines that the appropriate person is requesting medication, then the internal computer will determine if medication is due. If medication is not due, the dispenser will appropriately alert the user that medication is not due. This alert may include the display of a red light and/or a voice alert indicating how many minutes the user must wait for the next dose. This alert may be modified to communicate with the user based on his or her needs. After each dispense or at another frequency determined by both the provider and the user, the device may alert the patient as to how many pills are remaining within the device.

Additionally, the practitioner may set the dispenser to not fill prior “skipped doses.” For example, if a medication is written for every four hours as needed, and if a user goes eight hours without requesting medication and then requests medication, then he/she may only be given one dose and will not be able to request another one until another four hours has passed.

Another portion of the exterior contains a port that serves as a method to communicate with the device via a communication method (such as Bluetooth or infrared), although the device is capable of communicating via other means, including Bluetooth (see FIG. 2). The device will also contain an opening in the container through which medication is dispensed.

In the internal component of the dispenser, there exists a location for the pills, hereby known as the “belt”, and a mechanism by which to move the pills (see FIG. 4). The moving mechanism will likely be located in the center of the belt. The moving mechanism receives instructions on when to run from the internal computer.

Each pill is placed in an individual compartment that assures that the appropriate number of pills is dispensed with each movement of the belt. With each dispense, the mechanism moves enough to push the pills to the external part of the tube, which is accessible by the user. Additionally, there may be two layers of the belt so that a larger number of pills may be held by the belt as well as dispensed. The belt is comprised of separate compartments, so that, with a designated turn of the conveyer belt, the appropriate amount of medication will be dispensed.

The device also contains a locking mechanism (see FIG. 4). The proposed locking mechanism may be internal and controlled by an internal computer. It may, although not necessarily, operate in a manner in which the belt moves into a locking position and can rewind into the unlocked position. The internal computer will document each time the device is unlocked and by whom it was unlocked. This information can be stored in a log that may only be deleted by authorized personnel.

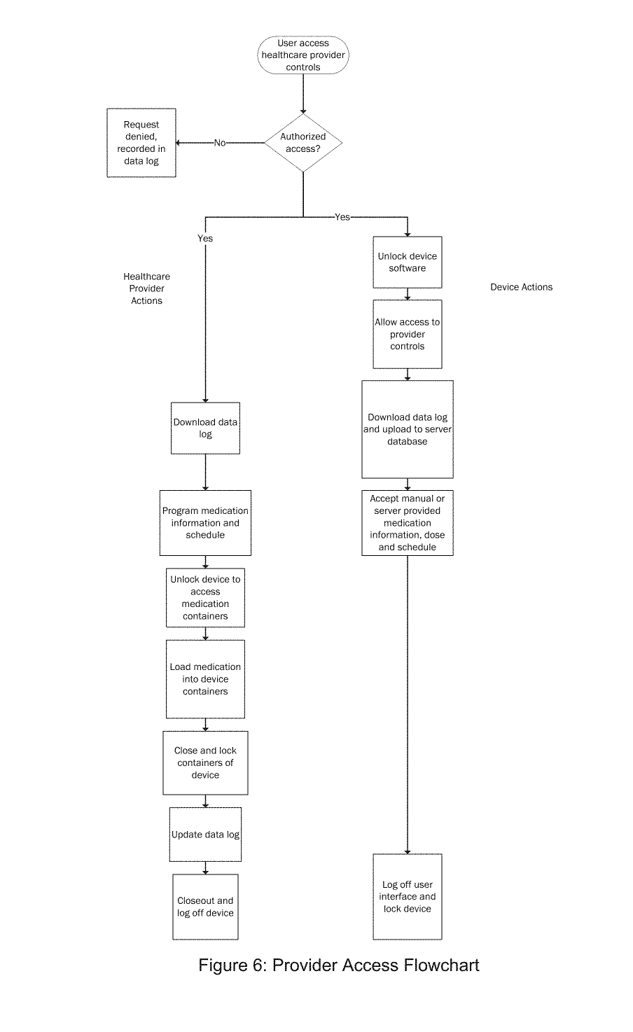

An authorized healthcare provider will have access to the logs, as well as have the ability to program user input requirements and dosage schedule through the use of a security controller, hereby known as the “the control pad” (see FIG. 6). The control pad should provide the only means of communication with the dispensing device. The user interface of the control pad may contain, although it is not limited to, a touch screen. Access to the control pad may be granted by verification of the authorized healthcare provider identification input.

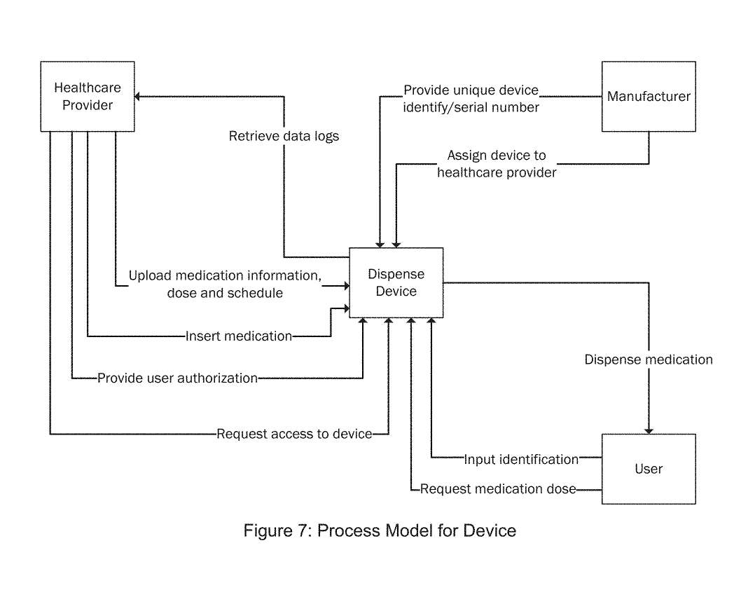

To prevent unauthorized access to the dispensing device, the control pad is only accessible by an authorized healthcare provider designated by an official from the control pad's manufacturer. This restriction ensures that if the control pad is stolen, the control pad would not cause harm. Additionally, to assure that the authorized healthcare provider remains licensed to provide the medication, access to the control pad may be limited to six months or another specified frequency, after which the practitioner would need to be reinstated (see FIG. 7 for process model).

By logging into the control pad, the practitioner can perform several functions such as, but not limited to, 1) opening the dispenser to access medications, 2) changing frequency of medication distribution from the dispenser, 3) checking the battery life of the dispenser, 4) determining the number of pills given by the dispenser, 5) determining how many attempts were made for medication by unauthorized person, and 6) determining how many denied medication requests were made for authorized user.

The aforementioned description should not be construed as limiting the scope of the invention. For example, the dispensing mechanics may take many different forms including delivering a product other than medication. Additionally the method of communicating with the user and/or provider may take many different forms. Because of these variations, the scope of the invention should be fixed by the claims rather than by any specific examples provided above.

1. A dispensing device that prohibits access to internal contents other than in an authorized dosage by an authorized user and at an authorized time,
the device comprising:
a. One or more containers for a purpose of holding one or more capsules, medication, or other content,
b. One or more locking mechanisms that prevent user access into said container when said locking mechanism is engaged,
c. One or more portals equipped to receive input or inputs from an authorized provider and/or user,
d. One or more internal computers for processing current time and/or time elapsed from a previous distribution of contents,
e. One or more internal computers to allow an authorized provider to program into said device one or more identification input requirements of an authorized user, a maximum number of doses, a minimum interval of time between doses, a specified time or times of day that said user is authorized to access content stored in said device, and/or an amount or dosage of internal contents to be accessed by user,
f. One or more internal computers to evaluate time and/or user input,
g. One or more devices to perform an operation of allowing access to contents, and
h. One or more openings in said containers from which to dispense internal contents.

2. The dispensing device of claim 1, further comprising one or more parts having an ability to move incrementally in a path for a purpose of rendering one or more capsules, unit of medication, or other content into a segment of the device accessible to a user.

3. The dispensing device of claim 1 or 2, wherein the identification input requirement or requirements of user are programmable.

4. The dispensing device of claim 1 or 2, wherein the amount or dosage of internal content to be accessed by user is programmable.

5. The dispensing device of claim 1 or 2, wherein a maximum number of doses, minimum elapsed time from previous dispersion, and/or a specified time or times of day that a user is authorized to access content stored are independently programmable.

6. The dispensing device of claim 1 or 2, wherein said device contains an identity portal for acquiring user identification input, including fingerprint recognition device, voice recognition, and/or passcode input.

7. The dispensing device of claim 1 or 2, wherein said device can evaluate whether current number of doses, elapsed time from previous dispersion, and/or a time of day, dosage of medicine, and/or one or more user inputs meet one or more programmed requirements.

8. The dispensing device of claim 1 or 2, wherein authorized time or times of medication can be based upon time of day, quantity of medication dispensed at a prior request or requests, elapsed time from prior dispersion or dispersions, or a combination thereof.

9. The dispensing device of claim 1 or 2, wherein said device will dispense one or more of its internal content only if current number of doses, elapsed time from previous dispersion, time of day, dosage, and/or identification input requirements are satisfied.

10. The dispensing device of claim 1 or 2, wherein said device controls the amount of capsules, medication, or other content that is dispensed at one time.

11. The dispensing device of claim 1 or 2, wherein said device dispenses only an authorized dosage during distribution of its content.

12. The dispensing device of claim 1 or 2, wherein locking mechanism engages after an authorized dosage is dispensed.

13. The dispensing device of claim 1 or 2, wherein said device contains a mechanism for creating an audible alert.

14. The dispensing device of claim 1 or 2, wherein said device records a log that can be accessed by an authorized provider or designated personnel, the log comprising one or more details of operation of said device.

15. The dispensing device of claim 1 or 2, wherein said device can be programmed through a designated controller to which an authorized provider has access.

16. The dispensing device of claim 1 or 2, wherein an authorized provider can fill said device with one of more capsules, medication, or other content.

17. The dispensing device of claim 1 or 2, wherein an authorized provider can select one or more identification input requirements of an authorized user.

18. The dispensing device of claim 1 or 2, wherein said device is assigned a unique device identifier.

19. The dispensing device of claim 1 or 2, wherein said device tracks the number of units of content contained within the device.

20. The dispensing device of claim 19, wherein said device contains a display disclosing the remaining quantity of contents enclosed within the device.

21. The dispensing device of claim 1 or 2, wherein said device comprises of one or more compartments, each compartment having an ability to be programmed with a different identification input, dosage, and/or time requirement.

22. The dispensing device of claim 1 or 2, wherein an authorized provider can refill and/or reprogram said device after use.

23. The dispensing device of claim 1 or 2, wherein said device is powered by electricity and/or battery.

24. The dispensing device of claim 1 or 2, wherein said device contains a battery charging port.

25. The dispensing device of claim 1 or 2, wherein said device and locking mechanism of device are tamper resistant.

26. The dispensing device of claim 1 or 2, wherein said device exhibits a sign of tampering after an attempt to open said device while locking mechanism is engaged.
